(19) United States
(12) Patent Application Publication
(10) Pub. No.: US 2024/0264644 A1
(43) Pub. Date: Aug. 8, 2024

(54) Computer Housing Assembly

(71) Applicant: John Gray, Wheeling, WV (US)

(72) Inventor: John Gray, Wheeling, WV (US)

(21) Appl. No.: 18/105,101

(22) Filed: Feb. 2, 2023

(51) Int. Cl. G06F 1/18; G06F 1/20

(52) U.S. Cl. CPC G06F 1/182; G06F 1/184; G06F 1/185; G06F 1/187; G06F 1/188; G06F 1/20

(57) ABSTRACT

A computer housing assembly for computer components includes a housing, which defines an interior space and which comprises wood. The components of a computer are positionable in the housing. The housing has a first sidewall, which is open. Each aperture of a plurality of apertures is positioned in the housing and is allows for insertion of a respective component or a user interface of the respective component. Each mounting element of a plurality of mounting elements is attached to the housing and is used to mount a respective component of the computer to the housing. A door is hingedly attached to the housing and is positioned to selectively close the first sidewall.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to computer housings and more particularly pertains to a new computer housing for computer components. The present invention discloses a housing made of wood and designed for mounting of the components of a computer.

### (2) Description of Related Art Including Information Disclosed Under 37 CFR 1.97 and 1.98

The prior art relates to computer housings, which include wood housings into which computers and other electronic devices are positionable, bamboo sleeves into which tablet computers are positionable, and housings comprised in part of wood. What is lacking in the prior art is a computer housing comprising wood and designed for mounting of the components of a computer.

### BRIEF SUMMARY OF THE INVENTION

An embodiment of the disclosure meets the needs presented above by generally comprising a housing, which defines an interior space and which comprises wood. The housing is configured for positioning of components of a computer. The housing has a first sidewall, which is open. Each aperture of a plurality of apertures is positioned in the housing and is configured for insertion of a respective component or a user interface of the respective component. Each mounting element of a plurality of mounting elements is attached to the housing and is configured to mount a respective component of the computer to the housing. A door is hingedly attached to the housing and is positioned to selectively close the first sidewall.

An embodiment of the disclosure includes a computer housing system, which comprises a housing and a computer, which comprises multiple components. The housing comprises wood and has a first sidewall that is open. Apertures in the housing are occupied by either a respective component or a user interface of the respective component. The components are mounted to the housing by associated mounting elements. A door selectively closes the first sidewall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a computer housing assembly according to an embodiment of the disclosure.

FIG. 2 is an isometric perspective view of an embodiment of the disclosure.

FIG. 3 is a side view of an embodiment of the disclosure.

FIG. 4 is an isometric perspective view of an embodiment of the disclosure.

FIG. 5 is an in-use view of an embodiment of the disclosure.

FIG. 6 is an isometric perspective view of an embodiment of the disclosure.

FIG. 7 is an isometric perspective view of an embodiment of the disclosure.

### DETAILED DESCRIPTION OF THE INVENTION

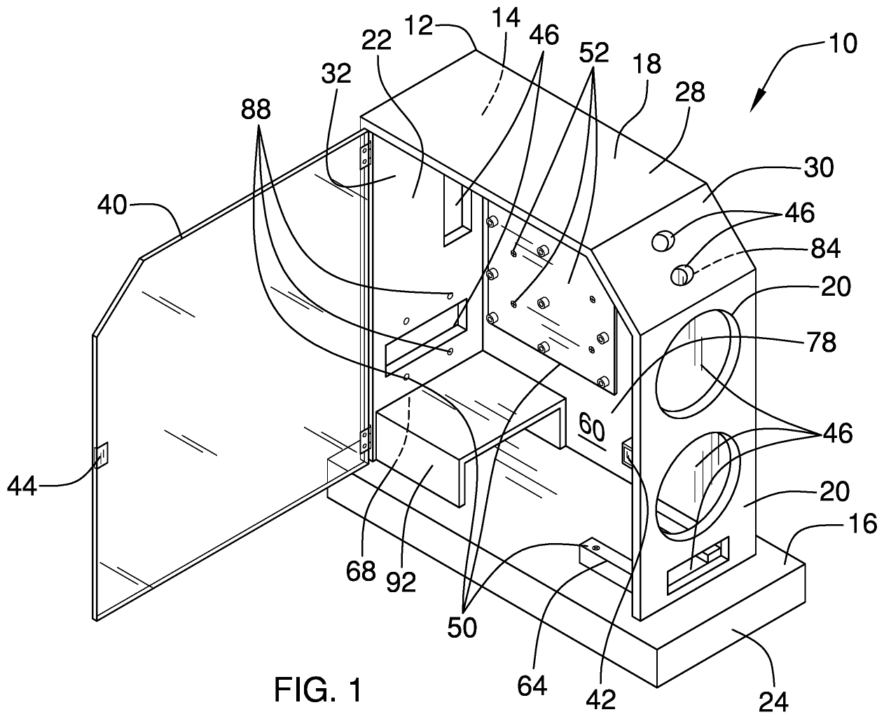

With reference now to the drawings, and in particular to FIGS. 1 through 7 thereof, a new computer housing embodying the principles and concepts of an embodiment of the disclosure and generally designated by the reference numeral 10 will be described.

As best illustrated in FIGS. 1 through 7, the computer housing assembly 10 generally comprises a housing 12, which defines an interior space 14 and which comprises wood. The housing 12 comprises a base 16 and a top 18. A front wall 20 and a rear wall 22 are attached to and extend substantially perpendicularly between the base 16 and the top 18 so that the housing 12 is substantially cuboid. The front wall 20 and the rear wall 22 are inset from a first end 24 and a second end 26 of the base 16, respectively, increasing stability of the housing 12.

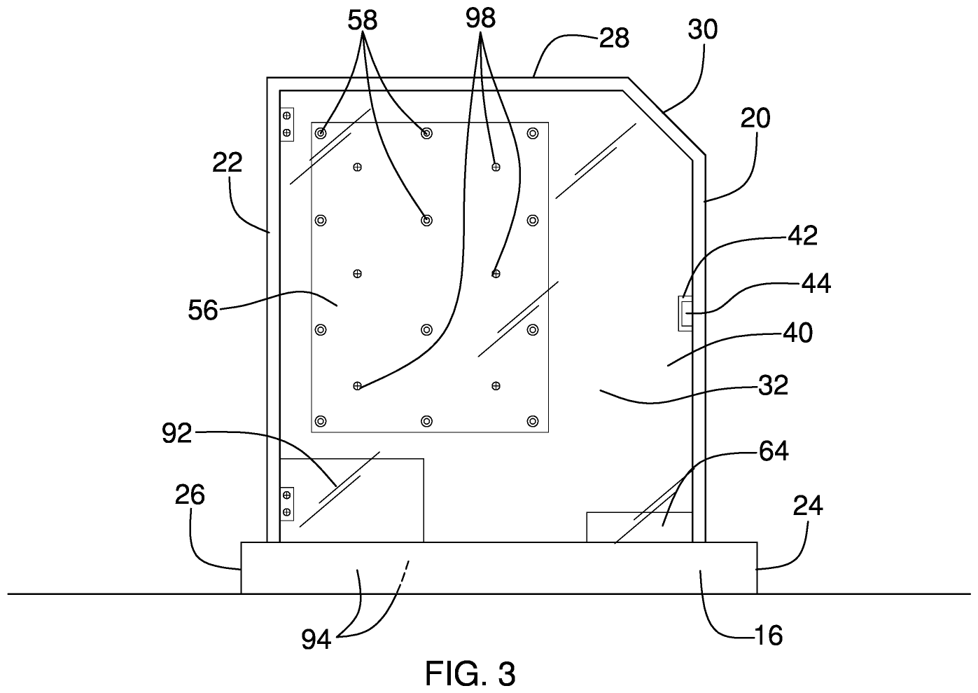

The front wall 20 is dimensionally shorter than the rear wall 22. The top 18 comprises a first section 28 and a second section 30. The first section 28 extends perpendicularly from the rear wall 22. The second section 30 is attached to the first section 28 distal from the rear wall 22 and to the front wall 20 distal from the base 16. Thus, as shown in FIG. 3, the second section 30 extends angularly between the first section 28 and the front wall 20.

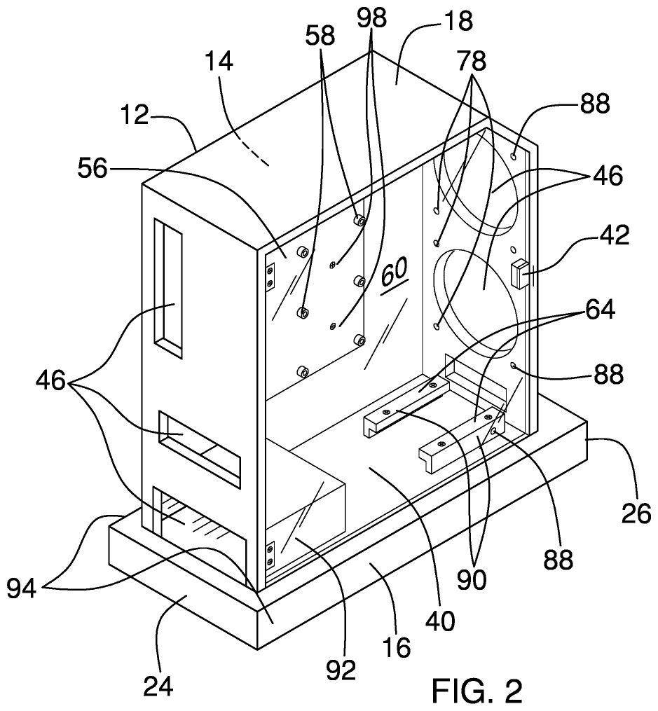

A first sidewall 32, which is open, and a second sidewall 34 are attached to and extend between the base 16 and the top 18. The second sidewall 34 is attached to and extends between the front wall 20 and the rear wall 22. As shown in FIG. 2, the first sidewall 32 and the second sidewall 44 are inset from opposed sides 94 of the base 16, thereby increasing the stability of the housing 12. The housing 12 is configured for positioning of components 36 of a computer 38. While specific components 36 of computers 38 are discussed in detail below, it should be understood that a variety of other components 36 are used in computers 38, and these are anticipated by the present invention.

A door 40 is hingedly attached to the housing 12 and is positioned to selectively close the first sidewall 32. The door 40 comprises wood or glass. The door 40 may be fastened closed by means of a magnet 42 and a strike plate 44, as shown in FIG. 1, or by a variety of other means known to those skilled in the art of door fasteners, such as, but not limited to, latches, bolts, and the like. With the door 40 comprising glass, the computer 38 is effectively on display and can serve as a decorative element to an office or other workspace.

Each aperture 46 of a plurality of apertures 46 is positioned in the housing 12 and is configured for insertion of a respective component 36 or a user interface 48 of the respective component 36. Each mounting element 50 of a plurality of mounting elements 50 is attached to the housing 12 and is configured to mount a respective component 36 of the computer 38 to the housing 12.

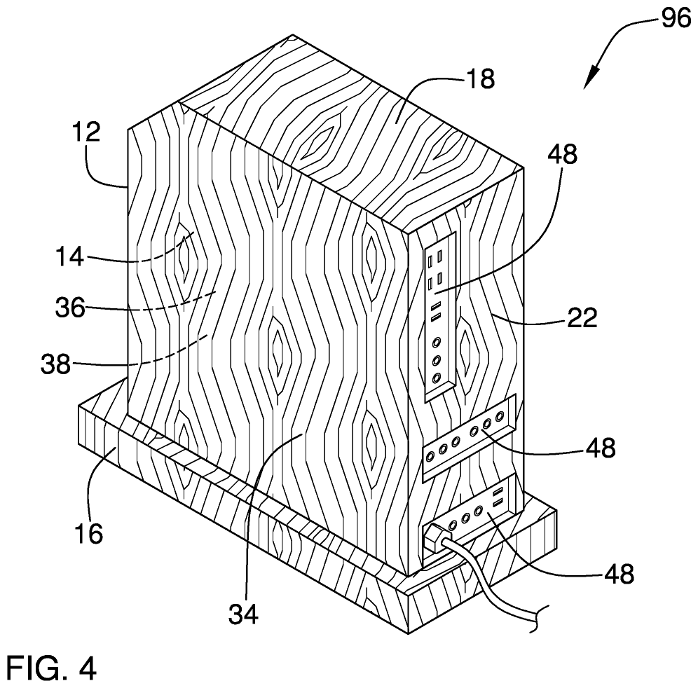

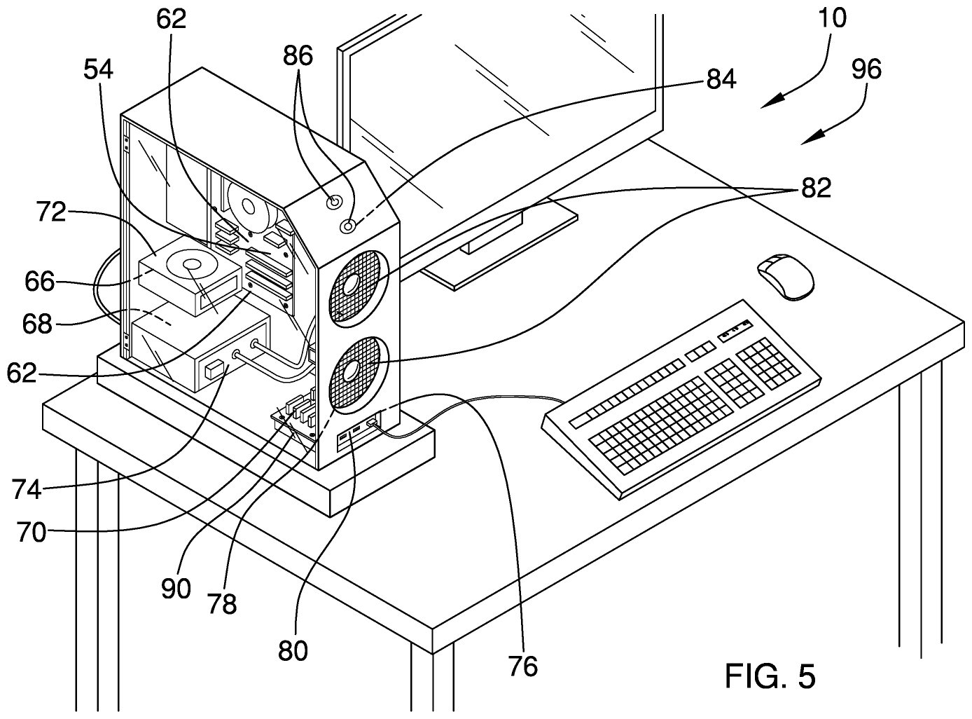

The plurality of mounting elements 50 comprises a board mount 52, which is configured to engage a motherboard 54 so that the motherboard 54 is mounted to the housing 12 and positioned in the interior space 14. As shown in FIG. 4, the user interface 48 of the motherboard 54 extends into an associated aperture 46 in the rear wall 22 of the housing 12. The board mount 52 may comprise one or both of a plate 56 and a plurality of standoff fasteners 58. As shown in FIGS. 1-3, the plate 56 is attached to an interior face 60 of the second sidewall 34 using screws 98, adhesives, or the like, with the motherboard 54 being selectively attachable to the plate 56 using standoff fasteners 58 thereby preventing metal to metal contact between the motherboard 54 and the plate 56. The plate 56 serves to protect the housing 12 from heat generated by the motherboard 54. The present invention also anticipates the standoff fasteners 58 being used for directly mounting the motherboard 54 to the housing 12, as is shown in FIG. 5.

The plurality of mounting elements 50 also comprises a drive mount 64, a card mount 66, and a power unit mount 68. The drive mount 64 is configured to engage a solid state drive 70 so that the solid state drive 70 is mounted to the housing 12 and is positioned in the interior space 14. The card mount 66 is configured to engage a graphics card 72 so that the graphics card 72 is mounted to the housing 12 and is positioned in the interior space 14, with the user interface 48 of the graphics card 72 extending into an associated aperture 46 that is positioned in the rear wall 22 of the housing 12. The power unit mount 68 is configured to engage a power supply unit 74 so that the power supply unit 74 is mounted to the housing 12 and is positioned in the interior space 14, with the user interface 48 of the power supply unit 74 extending into an associated aperture 46 that is positioned in the rear wall 22 of the housing 12.

The plurality of mounting elements 50 also comprises a hub mount 76 and a set of vent mounts 78. The hub mount 76 is configured to engage a Universal Serial Bus (USB) hub 80 so that the USB hub 80 is mounted to the housing 12 and is positioned in the interior space 14, with the user interface 48 of the USB hub 80 extending into an associated aperture 46 that is positioned in the front wall 20 of the housing 12. Each vent mount 78 is configured to engage a respective fan 82 of a set of fans 82 so that the respective fan 82 is mounted to the housing 12 and positioned in an associated aperture 46. As shown in FIG. 2, the associated aperture 46 for the respective fan 82 is positioned in the front wall 20 of the housing 12.

The plurality of mounting elements 50 also comprises a set of switch mounts 84, each of which is configured to engage a respective button 86 of a set of buttons 86 so that the respective button 86 is mounted to the housing 12 and is positioned in an associated aperture 46. As shown in FIG. 1, the apertures 46 for the buttons 86 are positioned in the top 18 of the housing 12, specifically the second section 30 of the top 18. The buttons 86 could have various functions, such as Power On, Power Off, Reset, and the like.

A plurality of predrilled holes 88 positioned in the housing 12. Each of the card mount 66, the power unit mount 68, the hub mount 76, the vent mounts 78, and the switch mounts 84 comprises at least one predrilled hole 88. The drive mount 64 comprises a pair of L-brackets 90 and at least two predrilled holes 88. The present invention further anticipates the components 36 being mounted to the housing 12 using holes that are drilled by a user.

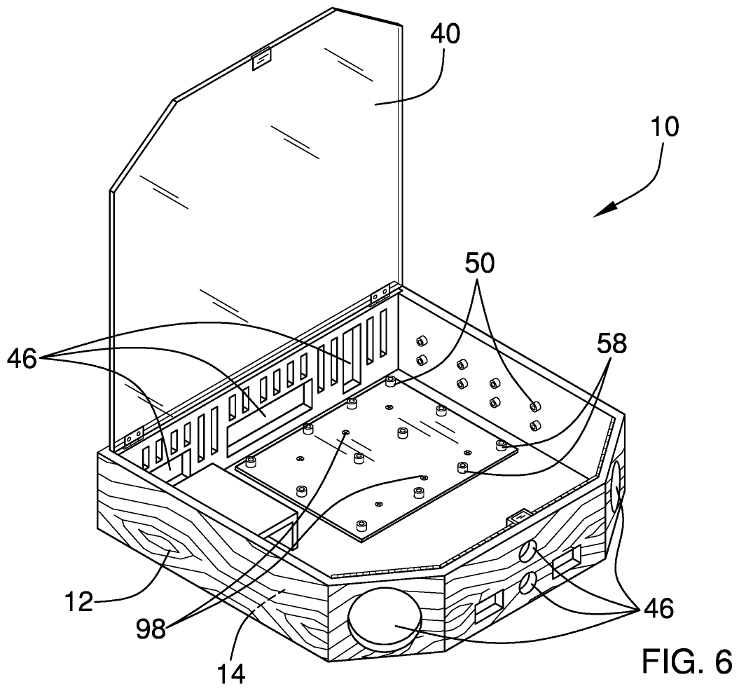

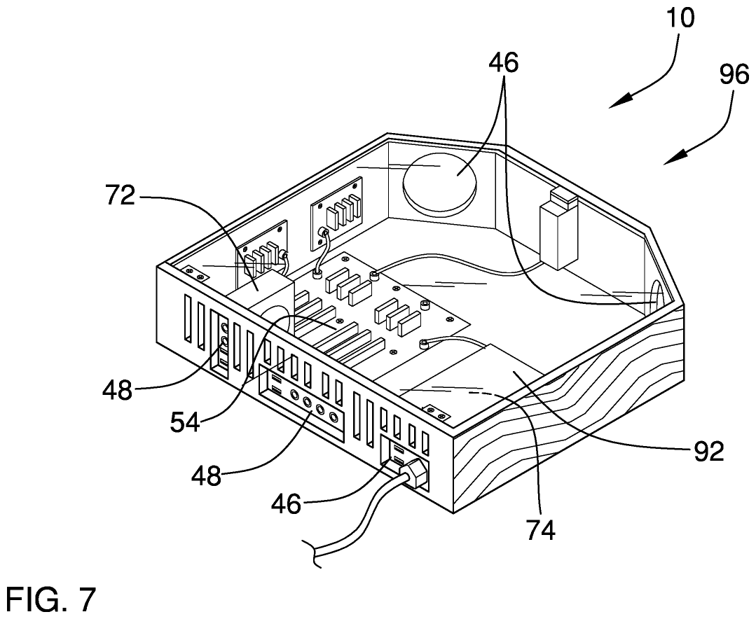

The computer housing assembly 10 also comprises a power unit cover 92, which comprises wood. The power unit cover 92 is configured to be positioned over the power supply unit 74 upon mounting of the power supply unit 74 to the housing 12. The present invention anticipates numerous alternative configurations of the computer housing assembly 10, one of which is shown in FIGS. 6 and 7.

The present invention also anticipates a computer housing system 96, which comprises a housing 12, which defines an interior space 14, and a computer 38, which comprises multiple components 36. The housing 12 comprises wood and has a first sidewall 32 that is open. A plurality of apertures 46 is positioned in the housing 12, with each aperture 46 being occupied by either a respective component 36 or a user interface 48 of the respective component 36. The components 36 are mounted to the housing 12 by associated mounting elements 50 of a plurality of mounting elements 50. A door 40 is hingedly attached to the housing 12 and selectively closes the first sidewall 32.

In use, the components 36 of a computer 38 are positioned in the housing 12 through the first sidewall 32, which is open. Each component 36 with a user interface 48 is attached to the housing 12 using its associated mounting element 50, with its user interface 48 positioned in an associated aperture 46. Components 36 lacking a user interface 48 are simply mounted to the housing 12 with their associated mounting elements 50. While one function of the present invention is to increase aesthetic appeal relative to prior art computer housings, the computer housing assembly 10 also provides functional advantages over the prior art, such as, but not limited to, the base 16 providing increased stability and the door 40 providing more facile access to the components 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A computer housing assembly comprising:
a housing defining an interior space configured for positioning of components of a computer, the housing comprising wood, the housing having a first sidewall, the first sidewall being open;
a plurality of apertures positioned in the housing, each aperture being configured for insertion of a respective component or a user interface of the respective component;
a plurality of mounting elements attached to the housing, each mounting element being configured for mounting a respective component of the computer to the housing; and
a door hingedly attached to the housing, such that the door is positioned for selectively closing the first sidewall.

2. The computer housing assembly of claim 1, wherein the housing comprises:
a base;
a top;
a front wall and a rear wall attached to and extending substantially perpendicularly between the base and the top, such that the housing is substantially cuboid, the front wall and the rear wall being inset from a first end and a second end of the base, respectively; and
a second sidewall attached to and extending between the base and the top, the second sidewall being attached to and extending between the front wall and the rear wall.

3. The computer housing assembly of claim 2, wherein:
the front wall is dimensionally shorter than the rear wall; and
the top comprises:
a first section extending perpendicularly from the rear wall, and
a second section attached to the first section distal from the rear wall, the second section being attached to the front wall distal from the base, such that the second section extends angularly between the first section and the front wall.

4. The computer housing assembly of claim 2, wherein the plurality of mounting elements comprises:
a board mount configured for engaging a motherboard, such that the motherboard is mounted to the housing and positioned in the interior space, with the user interface of the motherboard extending into an associated aperture in the rear wall of the housing;
a drive mount configured for engaging a solid state drive, such that the solid state drive is mounted to the housing and positioned in the interior space;
a card mount configured for engaging a graphics card, such that the graphics card is mounted to the housing and positioned in the interior space, with the user interface of the graphics card extending into an associated aperture positioned in the rear wall of the housing;
a power unit mount configured for engaging a power supply unit, such that the power supply unit is mounted to the housing and positioned in the interior space, with the user interface of the power supply unit extending into an associated aperture positioned in the rear wall of the housing;
a hub mount configured for engaging a Universal Serial Bus (USB) hub, such that the USB hub is mounted to the housing and positioned in the interior space, with the user interface of the USB hub extending into an associated aperture positioned in the front wall of the housing;
a set of vent mounts, each vent mount being configured for engaging a respective fan of a set of fans, such that the respective fan is mounted to the housing and positioned in an associated aperture; and
a set of switch mounts, each switch mount being configured for engaging a respective button of a set of buttons, such that the respective button is mounted to the housing and positioned in an associated aperture.

5. The computer housing assembly of claim 4, wherein:
the associated aperture for the respective fan is positioned in the front wall of the housing; and
the apertures for the buttons are positioned in the top of the housing.

6. The computer housing assembly of claim 4, wherein the board mount comprises one or both of:
a plate attached to the housing; and
a plurality of standoff fasteners attached to and extending from the plate, each standoff fastener being configured attachment to the motherboard, such that the motherboard is mounted to the plate.

7. The computer housing assembly of claim 6, wherein the plate is attached to an interior face of the second sidewall.

8. The computer housing assembly of claim 4, further including a plurality of predrilled holes positioned in the housing, each of the card mount, the power unit mount, the hub mount, the vent mounts, and the switch mounts comprising at least one predrilled hole, the drive mount comprising a pair of L-brackets and at least two predrilled holes.

9. The computer housing assembly of claim 4, further including a power unit cover configured for positioning over the power supply unit upon mounting of the power supply unit to the housing, the power unit cover comprising wood.

10. The computer housing assembly of claim 4, wherein the door comprises wood or glass.

11. A computer housing system comprising:
a housing defining an interior space, the housing comprising wood, the housing having a first sidewall, the first sidewall being open;
a computer comprising multiple components;
a plurality of apertures positioned in the housing, each aperture being occupied by either a respective component or a user interface of the respective component;
a plurality of mounting elements attached to the housing, each mounting element being attached to a respective component of the computer, such that the respective component is mounted to the housing; and
a door hingedly attached to the housing, such that the door is positioned for selectively closing the first sidewall.

12. The computer housing system of claim 11, wherein the housing comprises:
a base;
a top;
a front wall and a rear wall attached to and extending substantially perpendicularly between the base and the top, such that the housing is substantially cuboid, the front wall and the rear wall being inset from a first end and a second end of the base, respectively; and
a second sidewall attached to and extending between the base and the top, the second sidewall being attached to and extending between the front wall and the rear wall.

13. The computer housing system of claim 12, wherein the multiple components comprises:
a motherboard mounted to the housing and positioned, the user interface of the motherboard extending into an associated aperture in the rear wall of the housing;
a solid state drive mounted to the housing and positioned in the interior space;
a graphics card mounted to the housing and positioned in the interior space, the user interface of the graphics card extending into an associated aperture positioned in the rear wall of the housing;
a power supply unit mounted to the housing and positioned in the interior space, the user interface of the power supply unit extending into an associated aperture positioned in the rear wall of the housing;
a Universal Serial Bus (USB) hub mounted to the housing and positioned in the interior space, the user interface of the USB hub extending into an associated aperture positioned in the front wall of the housing;
a set of fans mounted to the housing, each fan being positioned in an associated aperture; and
a set of buttons mounted to the housing, each button being positioned in an associated aperture.

14. A computer housing assembly comprising:
a housing defining an interior space configured for positioning of components of a computer, the housing comprising wood, the housing having a first sidewall, the first sidewall being open, the housing comprising:
a base,
a top,
a front wall and a rear wall attached to and extending substantially perpendicularly between the base and the top, such that the housing is substantially cuboid, the front wall and the rear wall being inset from a first end and a second end of the base, respectively, the front wall being dimensionally shorter than the rear wall, the top comprising:
a first section extending perpendicularly from the rear wall, and
a second section attached to the first section distal from the rear wall, the second section being attached to the front wall distal from the base, such that the second section extends angularly between the first section and the front wall, and
a second sidewall attached to and extending between the base and the top, the second sidewall being attached to and extending between the front wall and the rear wall;
a plurality of apertures positioned in the housing, each aperture being configured for insertion of a respective component or a user interface of the respective component;
a plurality of mounting elements attached to the housing, each mounting element being configured for mounting a respective component of the computer to the housing, the plurality of mounting elements comprising:
a board mount configured for engaging a motherboard, such that the motherboard is mounted to the housing and positioned in the interior space, with the user interface of the motherboard extending into an associated aperture in the rear wall of the housing, the board mount comprising:
a plate attached to the housing, the plate being attached to an interior face of the second sidewall, and
a plurality of standoff fasteners attached to and extending from the plate, each standoff fastener being configured attachment to the motherboard, such that the motherboard is mounted to the plate,
a drive mount configured for engaging a solid state drive, such that the solid state drive is mounted to the housing and positioned in the interior space,
a card mount configured for engaging a graphics card, such that the graphics card is mounted to the housing and positioned in the interior space, with the user interface of the graphics card extending into an associated aperture positioned in the rear wall of the housing,
a power unit mount configured for engaging a power supply unit, such that the power supply unit is mounted to the housing and positioned in the interior space, with the user interface of the power supply unit extending into an associated aperture positioned in the rear wall of the housing,
a hub mount configured for engaging a Universal Serial Bus (USB) hub, such that the USB hub is mounted to the housing and positioned in the interior space, with the user interface of the USB hub extending into an associated aperture positioned in the front wall of the housing,
a set of vent mounts, each vent mount being configured for engaging a respective fan of a set of fans, such that the respective fan is mounted to the housing and positioned in an associated aperture, the associated aperture for the respective fan being positioned in the front wall of the housing, and
a set of switch mounts, each switch mount being configured for engaging a respective button of a set of buttons, such that the respective button is mounted to the housing and positioned in an associated aperture, the apertures for the buttons being positioned in the top of the housing;
a plurality of predrilled holes positioned in the housing, each of the card mount, the power unit mount, the hub mount, the vent mounts, and the switch mounts comprising at least one predrilled hole, the drive mount comprising a pair of L-brackets and at least two predrilled holes;
a power unit cover configured for positioning over the power supply unit upon mounting of the power supply unit to the housing, the power unit cover comprising wood; and
a door hingedly attached to the housing, such that the door is positioned for selectively closing the first sidewall, the door comprising wood or glass.
